(19) United States
(12) Patent Application Publication
(10) Pub. No.: US 2024/0153500 A1
(43) Pub. Date: May 9, 2024

(54) DATA PROCESSING METHOD, APPARATUS, AND DEVICE

(71) Applicant: Alipay (Hangzhou) Information Technology Co., Ltd., Hangzhou (CN)

(72) Inventors: Wenbiao ZHAO, Hangzhou (CN); Jinzhen LIN, Hangzhou (CN); Zhenzhe YING, Hangzhou (CN); Lanqing XUE, Hangzhou (CN); Weiqiang WANG, Hangzhou (CN); Ke XU, Hangzhou (CN); Qi LI, Hangzhou (CN)

(21) Appl. No.: 18/500,969

(22) Filed: Nov. 2, 2023

(30) Foreign Application Priority Data
Nov. 3, 2022 (CN) 202211369675.4

(51) Int. Cl. G10L 15/18; G06F 3/01; G06N 20/00; G10L 15/06; G10L 15/197

(52) U.S. Cl. CPC G10L 15/1815; G06F 3/011; G06N 20/00; G10L 15/063; G10L 15/197; G10L 2015/088

(57) ABSTRACT

Implementations of the present specification provide a data processing method, apparatus, and device. The method includes: obtaining to-be-detected target data, and obtaining a target probability that the target data corresponds to each candidate user intention, where the target data includes input data of a user in a human-computer interaction process; dividing the target data to obtain a plurality of pieces of subdata, and obtaining, based on a predetermined gradient integration algorithm, a contribution of each piece of subdata to a correspondence between the target data and each candidate user intention; and determining a target user intention corresponding to the target data based on the target probability that the target data corresponds to each candidate user intention and the contribution of each piece of subdata to the correspondence between the target data and each candidate user intention.

### TECHNICAL FIELD

Implementations of the present specification relate to the field of data processing technologies, and in particular, to a data processing method, apparatus, and device.

### BACKGROUND

With rapid development of the Internet industry, network risks also increase accordingly. In a risk control scenario, before application service providers provide services for users, customer service employees can interact with the users to determine, based on feedback information of the users, whether there is a risk in a current service (such as a transfer service, a recharging service, or a withdrawal service). To reduce costs of manual participation, risk control can be performed through human-computer interaction.

For example, a real user intention corresponding to the feedback information of the user can be determined by using a pretrained intention recognition model, to perform risk control on the current service. However, due to various fraudulent activities and complex feedback information of the user, the pretrained intention recognition model is possibly unable to accurately recognize a real intention of the user, and a risk control effect is poor.

### SUMMARY

Implementations of the present specification aim to provide a data processing method, apparatus, and device, to provide a solution that can accurately determine a real intention of a user in time in a risk control scenario to perform risk control.

To implement the above technical solutions, the present specification includes implementations as follows.

According to an aspect, an implementation of the present specification provides a data processing method, including: obtaining to-be-detected target data, and obtaining a target probability that the target data corresponds to each candidate user intention, where the target data includes input data of a user in a human-computer interaction process; dividing the target data to obtain a plurality of pieces of subdata, and obtaining, based on a predetermined gradient integration algorithm, a contribution of each piece of subdata to a correspondence between the target data and each candidate user intention; and determining a target user intention corresponding to the target data based on the target probability that the target data corresponds to each candidate user intention and the contribution of each piece of subdata to the correspondence between the target data and each candidate user intention.

According to an aspect, an implementation of the present specification provides a data processing apparatus, and the apparatus includes: a data acquisition module, configured to: obtain to-be-detected target data, and obtain a target probability that the target data corresponds to each candidate user intention, where the target data includes input data of a user in a human-computer interaction process; a contribution determining module, configured to: divide the target data to obtain a plurality of pieces of subdata, and obtain, based on a predetermined gradient integration algorithm, a contribution of each piece of subdata to a correspondence between the target data and each candidate user intention; and an intention determining module, configured to determine a target user intention corresponding to the target data based on the target probability that the target data corresponds to each candidate user intention and the contribution of each piece of subdata to the correspondence between the target data and each candidate user intention.

According to an aspect, an implementation of the present specification provides a data processing device. The data processing device includes: a processor, and a memory configured to store computer-executable instructions. When the executable instructions are executed, the processor is enabled to: obtain to-be-detected target data, and obtain a target probability that the target data corresponds to each candidate user intention, where the target data includes input data of a user in a human-computer interaction process; divide the target data to obtain a plurality of pieces of subdata, and obtain, based on a predetermined gradient integration algorithm, a contribution of each piece of subdata to a correspondence between the target data and each candidate user intention; and determine a target user intention corresponding to the target data based on the target probability that the target data corresponds to each candidate user intention and the contribution of each piece of subdata to the correspondence between the target data and each candidate user intention.

According to an aspect, an implementation of the present specification provides a storage medium. The storage medium is configured to store computer-executable instructions, and the following procedure is implemented when the executable instructions are executed: obtaining to-be-detected target data, and obtaining a target probability that the target data corresponds to each candidate user intention, where the target data includes input data of a user in a human-computer interaction process; dividing the target data to obtain a plurality of pieces of subdata, and obtaining, based on a predetermined gradient integration algorithm, a contribution of each piece of subdata to a correspondence between the target data and each candidate user intention; and determining a target user intention corresponding to the target data based on the target probability that the target data corresponds to each candidate user intention and the contribution of each piece of subdata to the correspondence between the target data and each candidate user intention.

### BRIEF DESCRIPTION OF DRAWINGS

To describe the technical solutions in the implementations of the present specification or in the existing technologies more clearly, the following is a brief introduction of the accompanying drawings for illustrating such technical solutions. Clearly, the accompanying drawings described below illustrate merely some example implementations of the present specification, and a person of ordinary skill in the art can derive other drawings from such accompanying drawings without making innovative efforts.

FIG. 1A is a flowchart illustrating a data processing method implementation according to the present specification;

FIG. 1B is a schematic diagram illustrating a processing process of a data processing method implementation according to the present specification;

FIG. 2 is a schematic diagram illustrating target data according to the present specification;

FIG. 3 is a schematic diagram illustrating a processing process of another data processing method implementation according to the present specification;

FIG. 4 is a schematic diagram illustrating a word vector determining method according to the present specification;

FIG. 5 is a schematic diagram illustrating a word vector according to the present specification;

FIG. 6 is a schematic diagram illustrating a structure of a data processing apparatus implementation according to the present specification; and

FIG. 7 is a schematic diagram illustrating a structure of a data processing device according to the present specification.

### DESCRIPTION OF EMBODIMENTS

Implementations of the present specification provide a data processing method, apparatus, and device.

To enable a person skilled in the art to better understand the technical solutions in the present specification, the following clearly and completely describes the technical solutions in the implementations of the present specification with reference to the accompanying drawings in the implementations of the present specification. Clearly, the described implementations are merely some rather than all of the implementations of the present specification. All other implementations obtained by a person of ordinary skill in the art based on the implementations of the present specification without making innovative efforts shall fall within the protection scope of the present specification.

In the specification, a “predetermined” value, parameter, threshold, condition or setting can be dynamically determined or adjusted by a machine with or without human inputs. A “predetermined” value, parameter, threshold, condition or setting does not mean or limit to that the value, parameter, threshold, condition or setting is fixed or is input by a human.

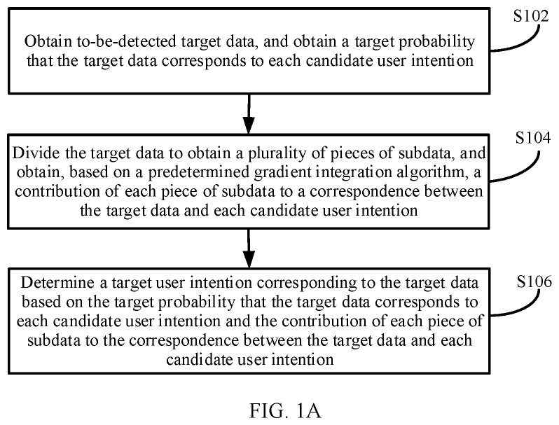

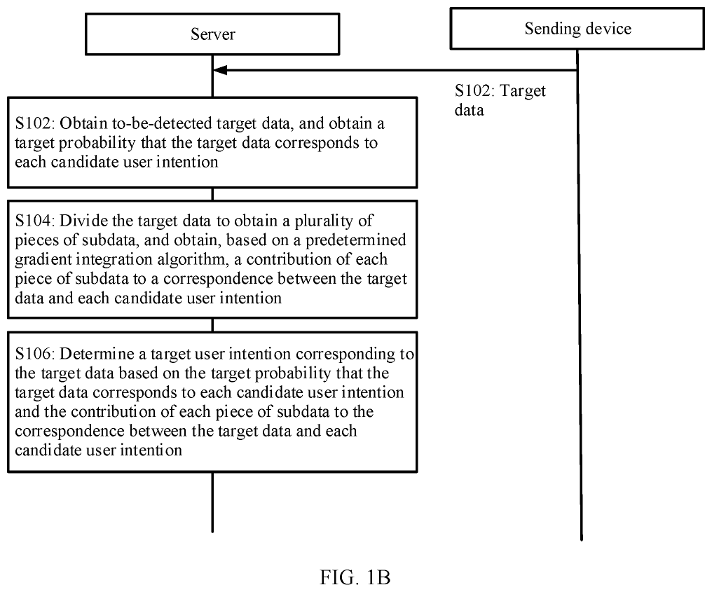

As shown in FIG. 1A and FIG. 1B, an implementation of the present specification provides a data processing method. The method can be performed by a server, and the server can be an independent server, or can be a server cluster including a plurality of servers. The method can, in some example implementations, include the following steps.

S102: Obtain to-be-detected target data, and obtain a target probability that the target data corresponds to each candidate user intention.

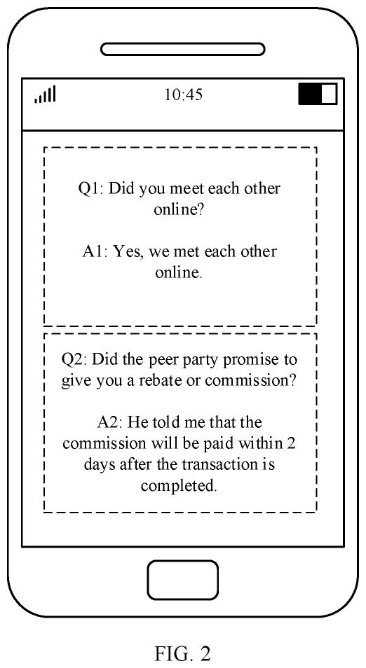

The target data may include data of a content of human-computer interaction, e.g., of a user, in a human-computer interaction process. The target data can include any type of data input by the user, such as voice data, image data, and text data. For example, as shown in FIG. 2, in a resource transfer service scenario, speech Q1 and speech Q2 can be output, and input data A1 of the user for speech Q1 and input data A2 of the user for speech Q2 can be received. In this case, the target data can include speech Q1, speech Q2, and the input data (for example, input data A1 and input data A2) of the user in the human-computer interaction process. The candidate user intention can be a user intention corresponding to a current scenario. For example, in the resource transfer service scenario, the candidate user intention can include a transfer intention and an information update intention.

With rapid development of the Internet industry, network risks also increase accordingly. In a risk control scenario, before application service providers provide services for users, customer service employees can interact with the users to determine, based on feedback information of the users, whether there is a risk in a current service (such as a transfer service, a recharging service, or a withdrawal service). To reduce costs of manual participation, risk control can be performed through human-computer interaction. For example, a real user intention corresponding to the feedback information of the user can be determined by using a pretrained intention recognition model, to perform risk control on the current service. However, due to various fraudulent methods in the black market and complex feedback information of the user, the pretrained intention recognition model is possibly unable to accurately recognize a real intention of the user, and a risk control effect is poor. Therefore, a solution that can accurately determine a real intention of a user in time in a risk control scenario is required to perform risk control. Therefore, implements of the present specification provides a technical solution that can resolve the above problem. For details, references can be made to the following content.

For example, the target data is text data. After the to-be-detected target data is obtained, keyword extraction processing can be performed on the target data to determine, by using a keyword included in the target data, the target probability that the target data corresponds to each candidate user intention. For example, if the target data includes keyword 1 and keyword 2, it can be determined, based on a predetermined correspondence between a keyword and a candidate user intention, that keyword 1 has a level of correspondence with candidate user intention 1 and candidate user intention 2, and that keyword 2 has a level of correspondence with candidate user intention 2. The target probability that the target data corresponds to each candidate user intention can be determined based on a predetermined weight of each keyword. For example, assuming that a weight of keyword 1 is 0.2 and a weight of keyword 2 is 0.15, it can be determined that the target probability that the target data corresponds to candidate user intention 1 can be 0.2, and that the target probability that the target data corresponds to candidate user intention 2 can be 0.2+0.15=0.35.

When keyword extraction processing is performed on the target data, keyword extraction can be performed by using a method such as a predetermined keyword extraction algorithm. Implements of the present specification is not specifically limited by any keyword extraction method.

If the target data includes voice data or video data, the server can perform text conversion processing on the obtained target data to obtain corresponding text data, and determine, based on the above target probability determining method, the target probability that the target data corresponds to each candidate user intention.

Alternatively or additionally, if the target data includes image data, the server can determine, by using a pretrained intention recognition model, the target probability that the target data corresponds to each candidate user intention. The intention recognition model can be a model that is constructed based on a predetermined deep learning algorithm and that is used to recognize a user intention.

The above method for determining the target probability that the target data corresponds to each candidate user intention is an example implementation of the specification. In an example application scenario, there can also be a plurality of different determining methods, and different determining methods can be selected based on different example application scenarios. Implements of the present specification is not specifically limited by any determining method.

S104: Divide the target data to obtain a plurality of pieces of subdata, and obtain, based on a predetermined gradient integration algorithm, a contribution of each piece of subdata to the target data being corresponding to each candidate user intention (or a contribution of each piece of subdata to a level of correspondence between the target data and each candidate user intention).

The predetermined gradient integration algorithm is an interpretable algorithm, and a degree of impact of a change in each piece of input data on a change in an output result can be calculated through gradient integration. Therefore, a degree of impact of a change in each piece of subdata on a change in the correspondence between the target data and each candidate user intention can be determined by using the predetermined gradient integration algorithm. As such, the contribution of each piece of subdata to a level of correspondence between the target data and each candidate user intention (or the target data being corresponding to each candidate user intention) can be determined.

In implementation, if the target data includes text data (or text data converted from voice data, video data, etc.), the target data can be divided based on a predetermined data division method to obtain a plurality of pieces of subdata. For example, the target data can be divided based on a character-based division method to obtain a plurality of pieces of subdata, or the target data can be divided based on a word-based division algorithm to obtain a plurality of pieces of subdata, or the target data can be divided based on a phase-based division method to obtain a plurality of pieces of subdata.

For example, the target data includes speech Q1 and input data A1 in FIG. 2. Speech Q1 and input data A1 can be divided based on the character-based division method to obtain a plurality of pieces of subdata, or speech Q1 and input data A1 can be divided based on the word-based division algorithm to obtain a plurality of pieces of subdata, or speech Q1 can be used as subdata 1 and input data A1 can be used as subdata 2, for example, speech Q1 and input data A1 are divided based on the phrase-based division method.

If the target data is image data, the server can divide the image data based on a predetermined fragment ratio to obtain a plurality of pieces of subdata, or can divide the image data based on a predetermined segmentation algorithm to obtain a plurality of pieces of subdata, etc.

The above described method for dividing the target data to obtain a plurality of pieces of subdata is an example implementation of dividing the target data. In an example application scenario, there can also be a plurality of different division methods, and different division methods can be selected based on different example application scenarios. Implements of the present specification are not specifically limited by any division method.

After the plurality of pieces of subdata are obtained, a degree of impact of a change in each piece of subdata to the correspondence between the target data belonging and each candidate user intention can be determined based on the predetermined gradient integration algorithm, and therefore, the contribution of each piece of subdata to the correspondence between the target data and each candidate user intention is determined.

S106: Determine a target user intention corresponding to the target data based on the target probability that the target data corresponds to each candidate user intention and the contribution of each piece of subdata to the correspondence between the target data and each candidate user intention.

In implementation, in an example application scenario, intention recognition can be multi-label text classification processing, for example, the target data can simultaneously belong to a plurality of categories. If a user intention fails to be recognized in intention recognition, the intention possibly does not exist in the target data, or the user intention possibly fails to be recognized due to interference of factors such as an expression manner. As such, it can be determined, based on the contribution of each piece of subdata to the correspondence between the target data and each candidate user intention, whether data possibly interfering with intention recognition accuracy, that is, subdata with a high negative contribution, exists in the target data.

For example, if a negative value exists in the contributions, it indicates that a contribution of the relevant subdata to a level of correspondence between the target data and a corresponding candidate user intention is a negative contribution, for example, which lowers the possibility the corresponding candidate user intention is a potential user intention of the target data.

Therefore, the target probability that the target data corresponds to each candidate user intention and the contribution of each piece of subdata to the level of correspondence between the target data and each candidate user intention can be combined to determine whether each candidate user intention is the target user intention corresponding to the target data.

For example, if a target probability that the target data corresponds to a candidate user intention is high, it can be determined that there is a high possibility that the candidate user intention is the target user intention corresponding to the target data. If a target probability that the target data corresponds to a candidate user intention is low and no negative value exists in the contributions (e.g., there is no negative contribution or no contribution that lowers the correspondence level), it can be determined that there is a low probability that the candidate user intention is the target user intention corresponding to the target data. If a target probability that the target data corresponds to a candidate user intention falls within an intermediate value range of the target probability and a negative value (e.g., a negative contribution) exists in the contributions, the candidate user intention can be determined as a potential user intention corresponding to the target data. The target user intention corresponding to the target data can be determined based on the candidate user intention(s) with a high probability and the potential user intention(s).

For example, assuming that the candidate user intention includes candidate user intention 1, candidate user intention 2, and candidate user intention 3, and the subdata has subdata 1 and subdata 2, the target probability that the target data corresponds to each candidate user intention and the contribution of each piece of subdata to the correspondence between the target data and each candidate user intention can be shown in the following Table 1.

TABLE 1

| | Contribution of | Contribution of | Target |
|---|---|---|---|
| | subdata 1 | subdata 2 | probability |
| Candidate user | 0.5 | 0.2 | 0.8 |
| intention 1 | | | |
| Candidate user | 0 | −0.5 | 0.5 |
| intention 2 | | | |
| Candidate user | 0 | 0 | 0.1 |
| intention 3 | | | |

As shown in Table 1, the target probability corresponding to candidate user intention 1 is greater than the target probabilities corresponding to candidate user intention 2 and candidate user intention 3. For example, there is a high probability that candidate user intention 1 is the target user intention corresponding to the target data. Because the target probability corresponding to candidate intention 3 is less than the target probabilities corresponding to candidate user intention 1 and candidate user intention 2, and no negative value exists in the contributions (e.g., no negative contribution exists), there is a low probability that candidate user intention 3 is the target user intention corresponding to the target data. The target probability corresponding to candidate user intention 2 is less than the target probability corresponding to candidate user intention 1 and greater than the target probability corresponding to candidate user intention 3, and the contribution of the subdata 2 in candidate user intention 2 is a negative value. Therefore, candidate user intention 2 is possibly a potential user intention. Finally, the target user intention corresponding to the target data can be determined based on candidate user intention 1 and candidate user intention 2.

The above method for determining the target user intention corresponding to the target data is an example implementation. In an example application scenario, there can also be a plurality of different determining methods, and different determining methods can be selected based on different example application scenarios. Implements of the present specification is not specifically limited by any determining method.

After the target user intention corresponding to the target data is determined, risk control can be performed on the target data for the target user intention; or a corresponding target speech can be determined based on the target user intention and returned to a terminal device, and then feedback information of the user for the target speech is further obtained to perform processing such as risk control.

According to the data processing method provided in an implementation of the present specification, to-be-detected target data is obtained, and a target probability that the target data corresponds to each candidate user intention is obtained, where the target data includes input data of a user in a human-computer interaction process; the target data is divided to obtain a plurality of pieces of subdata, and a contribution of each piece of subdata to a correspondence between the target data and each candidate user intention is obtained based on a predetermined gradient integration algorithm; and a target user intention corresponding to the target data is determined based on the target probability that the target data corresponds to each candidate user intention and the contribution of each piece of subdata to the correspondence between the target data and each candidate user intention. As such, it can be determined, based on the contribution of each piece of subdata to the correspondence between the target data and each candidate user intention, whether data possibly interfering with intention recognition accuracy, e.g., subdata with a high negative contribution, exists in the target data, and then the target user intention corresponding to the target data can be accurately determined with reference to the target probability that the target data corresponds to each candidate user intention, so that accuracy of determining a real intention of a user is improved, thereby improving accuracy of risk control.

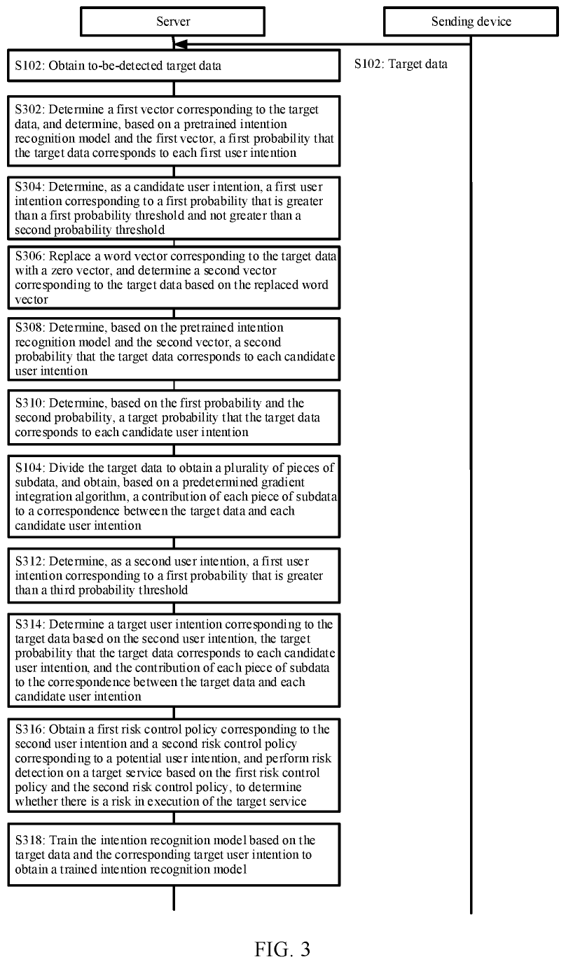

As shown in FIG. 3, an implementation of the present specification provides a data processing method. The method can be performed by a server, and the server can be an independent server, or can be a server cluster including a plurality of servers. The method can specifically include the following steps.

S102: Obtain to-be-detected target data.

S302: Determine a first vector corresponding to the target data, and determine, based on a pretrained intention recognition model and the first vector, a first probability that the target data corresponds to each first user intention.

The intention recognition model is a model that is constructed based on a predetermined deep learning algorithm and that is used to recognize a user intention, and the first user intention can be a user intention corresponding to a current scenario. For example, in a resource transfer service scenario, the first user intention can include a transfer intention and an information update intention.

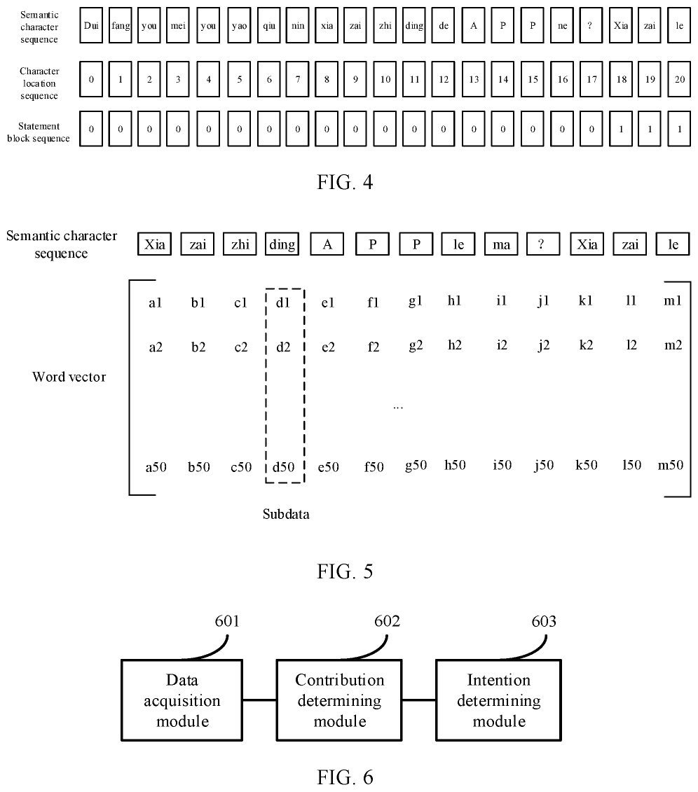

In some implementations, a Bert model is used as an example of the intention recognition model. As shown in FIG. 4, it is assumed that the target data is Chinese text “Dui fang you mei you yao qiu nin xia zai zhi ding de APP ne? Xia zai le” (in English, “Did the peer party ask you to download the specified APP? Downloaded”). A semantic character sequence, a character location sequence, and a statement block sequence that correspond to the target data can be obtained, a word vector(s) corresponding to the target data is determined based on the semantic character sequence, a location vector(s) corresponding to the target data is determined based on the character location sequence, and a segment vector(s) corresponding to the target data is determined based on the statement block sequence. Finally, the first vector corresponding to the target data is determined based on the word vector, the location vector, and the segment vector.

The first vector is input to the pretrained Bert model to obtain the first probability that the target data corresponds to each first user intention.

S304: Determine, as a candidate user intention, a first user intention corresponding to a first probability that is greater than a first probability threshold and not greater than a second probability threshold.

In implementation, if the first probability is large, there is a high probability that the first user intention is a target user intention corresponding to the target data; or if the first probability is small, there is a low probability that the first user intention is the target user intention corresponding to the target data. Therefore, the first user intention corresponding to the first probability that is greater than the first probability threshold and not greater than the second probability threshold can be determined as the candidate user intention. For example, it can be assumed that the first probability threshold is 0.1 and the second probability threshold is 0.5. In this case, a first user intention corresponding to a first probability greater than 0.1 and not greater than 0.5 can be determined as the candidate user intention.

S306: Replace a word vector corresponding to the target data with a replacement word vector, e.g., a zero vector, and determine a second vector corresponding to the target data based on the replacement word vector.

In implementation, in practice, there can be a variety of processing manners in S306. The following provides an example implementation. For details, references can be made to processing in the following step 1 and step 2.

Step 1: Obtain a location vector of each word in the target data and a segment vector of each word in the target data.

Step 2: Determine the second vector corresponding to the target data based on the replacement word vector, the location vector, and the segment vector.

In implementation, that the target data is the data shown in FIG. 4 is used as an example. The word vector corresponding to the semantic character sequence can be replaced with an identified non-semantic replacement word vector, e.g., a zero vector, and then the second vector corresponding to the target data is determined based on the replacement word vector (e.g., the zero vector), the location vector corresponding to the target data determined based on the character location sequence, and the segment vector corresponding to the target data determined based on the statement block sequence.

S308: Determine, based on the pretrained intention recognition model and the second vector, a second probability that the target data corresponds to each candidate user intention.

In implementation, the second vector can be input to the pretrained intention recognition model to obtain the second probability that the target data corresponds to each candidate user intention. As such, because the word vector for determining the second vector is the zero vector, the second probability, determined based on the second vector, that the target data corresponds to each candidate user intention is a probability that the target data corresponds to each candidate user intention that is determined without the semantic effect being considered.

S310: Determine, based on the first probability and the second probability, a target probability that the target data corresponds to each candidate user intention.

In implementation, the first probability is a probability obtained based on the first vector determined based on the word vector, the location vector, and the segment vector, and the second probability is a probability obtained based on the first vector determined based on the zero vector (e.g., the replacement word vector), the location vector, and the segment vector. Therefore, a difference between the first probability and the second probability can be determined as the target probability that the target data corresponds to each candidate user intention, to be specific, the target probability can be used to represent a contribute of a word included in the target data to a relationship between the target data and each candidate user intention.

S104: Divide the target data to obtain a plurality of pieces of subdata, and obtain, based on a predetermined gradient integration algorithm, a contribution of each piece of subdata to a correspondence between the target data and each candidate user intention.

In implementation, it is assumed that the target data is divided based on a character-based division method, and a word vector shown in FIG. 5 can be constructed based on the subdata obtained through division. The word vector can be constructed based on a predetermined dimension. For example, if the semantic character sequence includes 13 characters, and the predetermined dimension is 50, a size of the constructed word vector is 13*50.

The contribution of each piece of subdata to the correspondence (or correspondence level) between the target data and each candidate user intention can be obtained by using the predetermined gradient integration algorithm. A contribution matrix with a size the same as the size of the word vector (that is, the size is also 13*50) can be obtained by using the predetermined gradient integration algorithm, and a sum of contributions corresponding to each piece of subdata in the contribution matrix can be used as a contribution of the subdata to the correspondence between the target data belonging and each candidate user intention. For example, as shown in FIG. 5, a sum of contributions corresponding to d1 to d50 can be used as a contribution of a character “ding” to the correspondence between the target data and each candidate user intention.

S312: Determine, as a second user intention, a first user intention corresponding to a first probability that is greater than a third probability threshold.

S314: Determine the target user intention corresponding to the target data based on the second user intention, the target probability that the target data corresponds to each candidate user intention, and the contribution of each piece of subdata to the correspondence between the target data and each candidate user intention.

In implementation, there can be a variety of processing manners in S314. The following provides an example implementation. For details, references can be made to processing in the following step 1 and step 2.

Step 1: If a contribution less than a predetermined contribution threshold exists in the contributions, determine, as a potential user intention, a candidate user intention corresponding to the contribution less than the predetermined contribution threshold.

The contribution threshold can be a negative value. For example, whether subdata having a contribution has negative impact on the correspondence between the target data and a candidate user intention can be determined based on whether the contribution is less than the predetermined contribution threshold. For example, the predetermined contribution threshold can be −0.1, −0.2, etc. Different predetermined contribution thresholds can be selected based on different example application scenarios. Implements of the present specification are not specifically limited by any contribution threshold.

Step 2: Determine the target user intention corresponding to the target data based on the second user intention and the potential user intention.

In some example implementations, the target data, the second user intention, and the potential user intention can also be sent to be determined manually, and the manually determined target user intention corresponding to the target data is obtained.

Alternatively or additionally, the second user intention and the potential user intention can be determined as target user intentions corresponding to the target data.

The target data can be data required for performing a target service. For example, if the target service is a resource transfer service, the target data can include resource transfer time, a resource transfer amount, and input data of a user for a resource transfer speech.

S316: Obtain a first risk control policy corresponding to the second user intention and a second risk control policy corresponding to the potential user intention, and perform risk detection on the target service based on the first risk control policy and the second risk control policy, to determine whether there is a risk in execution of the target service.

The first risk control policy and the second risk control policy can be any policy that can perform risk control. For example, in a resource transfer scenario, the risk control policy can include a resource quantity limitation policy and a risk alarm policy. The first risk control policy and the second risk control policy can be any one or more of the above policies.

In implementation, the first risk control policy corresponding to the second user intention and the second risk control policy corresponding to the potential user intention can be obtained based on a predetermined correspondence between a user intention and a risk control policy, and risk detection is performed on the target service based on the first risk control policy and the second risk control policy, to determine whether there is a risk in execution of the target service.

The risk control policy can be determined by various methods. For example, keyword matching can be performed on the risk control policy based on a keyword included in the user intention, to determine the first risk control policy corresponding to the second user intention, the second risk control policy corresponding to the potential user intention, etc. Different methods for determining the risk control policy can be selected based on different example application scenarios. Implements of the present specification are not specifically limited by any determining method.

S318: Train the intention recognition model based on the target data and the corresponding target user intention to obtain a trained intention recognition model.

In implementation, the intention recognition model can be retrained based on the target data and the corresponding target user intention to obtain the trained intention recognition model, to improve accuracy of intention recognition of the trained intention recognition model.

According to the data processing method provided in implements of the present specification, to-be-detected target data is obtained, and a target probability that the target data corresponds to each candidate user intention is obtained, where the target data includes input data of a user in a human-computer interaction process; the target data is divided to obtain a plurality of pieces of subdata, and a contribution of each piece of subdata to a correspondence between the target data and each candidate user intention is obtained based on a predetermined gradient integration algorithm; and a target user intention corresponding to the target data is determined based on the target probability that the target data corresponds to each candidate user intention and the contribution of each piece of subdata to the correspondence between the target data and each candidate user intention. As such, it can be determined, based on the contribution of each piece of subdata to the correspondence between the target data and each candidate user intention, whether data possibly interfering with intention recognition accuracy, that is, subdata with a high negative contribution, exists in the target data, and then the target user intention corresponding to the target data can be accurately determined with reference to the target probability that the target data corresponds to each candidate user intention, so that accuracy of determining a real intention of a user is improved, thereby improving accuracy of risk control.

The data processing method provided in the implementations of the present specification is described above. Based on a similar idea, an implementation of the present specification further provides a data processing apparatus, as shown in FIG. 6.

The data processing apparatus includes a data acquisition module 601, a contribution determining module 602, and an intention determining module 603.

The data acquisition module 601 is configured to: obtain to-be-detected target data, and obtain a target probability that the target data corresponds to each candidate user intention, where the target data includes input data of a user in a human-computer interaction process.

The contribution determining module 602 is configured to: divide the target data to obtain a plurality of pieces of subdata, and obtain, based on a predetermined gradient integration algorithm, a contribution of each piece of subdata to a correspondence between the target data and each candidate user intention.

The intention determining module 603 is configured to determine a target user intention corresponding to the target data based on the target probability that the target data corresponds to each candidate user intention and the contribution of each piece of subdata to the correspondence between the target data and each candidate user intention.

In implements of the present specification, the apparatus further includes: a first determining module, configured to: determine a first vector corresponding to the target data, and determine, based on a pretrained intention recognition model and the first vector, a first probability that the target data corresponds to each first user intention, where the intention recognition model is a model that is constructed based on a predetermined deep learning algorithm and that is used to recognize a user intention; and a second determining module, configured to determine, as a candidate user intention, a first user intention corresponding to a first probability that is greater than a first probability threshold and not greater than a second probability threshold.

The intention determining module 603 is configured to: determine, as a second user intention, a first user intention corresponding to a first probability that is greater than a third probability threshold; and determine the target user intention corresponding to the target data based on the second user intention, the target probability that the target data corresponds to each candidate user intention, and the contribution of each piece of subdata to the correspondence between the target data and each candidate user intention.

In implements of the present specification, the data acquisition module 601 is configured to: replace a word vector corresponding to the target data with a zero vector, and determine a second vector corresponding to the target data based on the replacement word vector; determine, based on the pretrained intention recognition model and the second vector, a second probability that the target data corresponds to each candidate user intention; and determine, based on the first probability and the second probability, the target probability that the target data corresponds to each candidate user intention.

In implements of the present specification, the data acquisition module 601 is configured to: obtain a location vector of each word in the target data and a segment vector of each word in the target data; and determine the second vector corresponding to the target data based on the replacement word vector, the location vector, and the segment vector.

In implements of the present specification, the intention determining module 603 is configured to: if a contribution less than a predetermined contribution threshold exists in the contributions, determine, as a potential user intention, a candidate user intention corresponding to the contribution less than the predetermined contribution threshold; and determine the target user intention corresponding to the target data based on the second user intention and the potential user intention.

In implements of the present specification, the target data is data required for performing a target service, and the apparatus further includes: a risk detection module, configured to: obtain a first risk control policy corresponding to the second user intention and a second risk control policy corresponding to the potential user intention, and perform risk detection on the target service based on the first risk control policy and the second risk control policy, to determine whether there is a risk in execution of the target service.

In implements of the present specification, the apparatus further includes: a model training module, configured to train the intention recognition model based on the target data and the corresponding target user intention to obtain a trained intention recognition model.

According to the data processing apparatus provided in implements of the present specification, to-be-detected target data is obtained, and a target probability that the target data corresponds to each candidate user intention is obtained, where the target data includes input data of a user in a human-computer interaction process; the target data is divided to obtain a plurality of pieces of subdata, and a contribution of each piece of subdata to a correspondence between the target data and each candidate user intention is obtained based on a predetermined gradient integration algorithm; and a target user intention corresponding to the target data is determined based on the target probability that the target data corresponds to each candidate user intention and the contribution of each piece of subdata to the correspondence between the target data and each candidate user intention. As such, it can be determined, based on the contribution of each piece of subdata to the correspondence between the target data and each candidate user intention, whether data possibly interfering with intention recognition accuracy, that is, subdata with a high negative contribution, exists in the target data, and then the target user intention corresponding to the target data can be accurately determined with reference to the target probability that the target data corresponds to each candidate user intention, so that accuracy of determining a real intention of a user is improved, thereby improving accuracy of risk control.

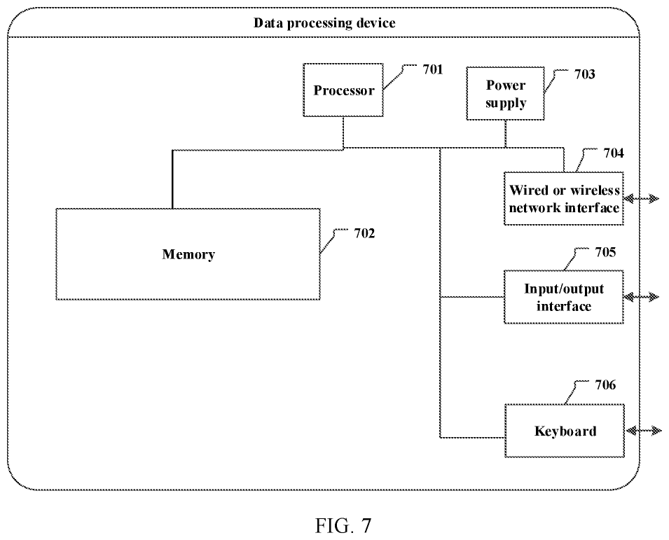

Based on a similar idea, an implementation of the present specification further provides a data processing device, as shown in FIG. 7.

The data processing device can have large differences due to different configuration or performance, and can include one or more processors 701 and memories 702. The memory 702 can store one or more storage application programs or data. The memory 702 can be used for short-term storage or persistent storage. The application program stored in the memory 702 can include one or more modules (not shown in the figure), and each module can include a series of computer-executable instructions in the data processing device. Further, the processor 701 can be configured to communicate with the memory 702, and execute the series of computer-executable instructions in the memory 702 on the data processing device. The data processing device can further include one or more power supplies 703, one or more wired or wireless network interfaces 704, one or more input/output interfaces 705, and one or more keyboards 706.

For example, in implements, the data processing device includes a memory and one or more programs, and the one or more programs are stored in the memory. The one or more programs can include one or more modules, and each module can include a series of computer-executable instructions in the data processing device. The one or more programs are configured to be executed by one or more processors and include computer-executable instructions used to perform the following operations: obtaining to-be-detected target data, and obtaining a target probability that the target data corresponds to each candidate user intention, where the target data includes input data of a user in a human-computer interaction process; dividing the target data to obtain a plurality of pieces of subdata, and obtaining, based on a predetermined gradient integration algorithm, a contribution of each piece of subdata to a correspondence between the target data and each candidate user intention; and determining a target user intention corresponding to the target data based on the target probability that the target data corresponds to each candidate user intention and the contribution of each piece of subdata to the correspondence between the target data and each candidate user intention.

In some implementations, before the obtaining the target probability that the target data corresponds to each candidate user intention, the following operations are further included: determining a first vector corresponding to the target data, and determining, based on a pretrained intention recognition model and the first vector, a first probability that the target data corresponds to each first user intention, where the intention recognition model is a model that is constructed based on a predetermined deep learning algorithm and that is used to recognize a user intention; and determining, as a candidate user intention, a first user intention corresponding to a first probability that is greater than a first probability threshold and not greater than a second probability threshold.

The determining the target user intention corresponding to the target data based on the target probability that the target data corresponds to each candidate user intention and the contribution of each piece of subdata to the correspondence between the target data and each candidate user intention includes: determining, as a second user intention, a first user intention corresponding to a first probability that is greater than a third probability threshold; and determining the target user intention corresponding to the target data based on the second user intention, the target probability that the target data corresponds to each candidate user intention, and the contribution of each piece of subdata to the correspondence between the target data and each candidate user intention.

In some implementations, the obtaining the target probability that the target data corresponds to each candidate user intention includes: replacing a word vector corresponding to the target data with a zero vector, and determining a second vector corresponding to the target data based on the replacement word vector; determining, based on the pretrained intention recognition model and the second vector, a second probability that the target data corresponds to each candidate user intention; and determining, based on the first probability and the second probability, the target probability that the target data corresponds to each candidate user intention.

In some implementations, the determining the second vector corresponding to the target data based on the replacement word vector includes: obtaining a location vector of each word in the target data and a segment vector of each word in the target data; and determining the second vector corresponding to the target data based on the replacement word vector, the location vector, and the segment vector.

In some implementations, the determining the target user intention corresponding to the target data based on the second user intention, the target probability that the target data corresponds to each candidate user intention, and the contribution of each piece of subdata to the correspondence between the target data and each candidate user intention includes: if a contribution less than a predetermined contribution threshold exists in the contributions, determining, as a potential user intention, a candidate user intention corresponding to the contribution less than the predetermined contribution threshold; and determining the target user intention corresponding to the target data based on the second user intention and the potential user intention.

In some implementations, the target data is data required for performing a target service, and the method further includes: obtaining a first risk control policy corresponding to the second user intention and a second risk control policy corresponding to the potential user intention, and performing risk detection on the target service based on the first risk control policy and the second risk control policy, to determine whether there is a risk in execution of the target service.

In some implementations, the method further includes: training the intention recognition model based on the target data and the corresponding target user intention to obtain a trained intention recognition model.

According to the data processing device provided in implements of the present specification, to-be-detected target data is obtained, and a target probability that the target data corresponds to each candidate user intention is obtained, where the target data includes input data of a user in a human-computer interaction process; the target data is divided to obtain a plurality of pieces of subdata, and a contribution of each piece of subdata to a correspondence between the target data and each candidate user intention is obtained based on a predetermined gradient integration algorithm; and a target user intention corresponding to the target data is determined based on the target probability that the target data corresponds to each candidate user intention and the contribution of each piece of subdata to the correspondence between the target data and each candidate user intention. As such, it can be determined, based on the contribution of each piece of subdata to the correspondence between the target data and each candidate user intention, whether data possibly interfering with intention recognition accuracy, that is, subdata with a high negative contribution, exists in the target data, and then the target user intention corresponding to the target data can be accurately determined with reference to the target probability that the target data corresponds to each candidate user intention, so that accuracy of determining a real intention of a user is improved, thereby improving accuracy of risk control.

An implementation of the present application further provides a computer-readable storage medium. The computer-readable storage medium stores a computer program. When the computer program is executed by a processor, the processes in the above data processing method implementations are implemented, and same technical effects can be achieved. To avoid repetition, details are omitted herein for simplicity. For example, the computer-readable storage medium is a read-only memory (ROM for short), a random access memory (RAM for short), a magnetic disk, or an optical disc.

According to the computer-readable storage medium provided in implements of the present specification, to-be-detected target data is obtained, and a target probability that the target data corresponds to each candidate user intention is obtained, where the target data includes input data of a user in a human-computer interaction process; the target data is divided to obtain a plurality of pieces of subdata, and a contribution of each piece of subdata to a correspondence between the target data and each candidate user intention is obtained based on a predetermined gradient integration algorithm; and a target user intention corresponding to the target data is determined based on the target probability that the target data corresponds to each candidate user intention and the contribution of each piece of subdata to the correspondence between the target data and each candidate user intention. As such, it can be determined, based on the contribution of each piece of subdata to the correspondence between the target data and each candidate user intention, whether data possibly interfering with intention recognition accuracy, e.g., subdata with a high negative contribution, exists in the target data, and then the target user intention corresponding to the target data can be accurately determined with reference to the target probability that the target data corresponds to each candidate user intention, so that accuracy of determining a real intention of a user is improved, thereby improving accuracy of risk control.

Example implementations of the present specification are described above. Other implementations fall within the scope of the appended claims. In some cases, the actions or steps described in the claims can be performed in an order different from that in the implementations and the desired results can still be achieved. In addition, the process depicted in the accompanying drawings does not necessarily need a particular execution order to achieve the desired results. In some implementations, multi-tasking and concurrent processing are feasible or can be advantageous.

In the 1990s, whether a technical improvement is a hardware improvement (for example, an improvement to a circuit structure such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application specific integrated circuit chip. In addition, at present, instead of manually manufacturing an integrated circuit chip, this type of programming is mostly implemented by using “logic compiler” software. The software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented in any suitable manner, for example, the controller can use a form such as a micro-processor, a processor, or a computer-readable medium, a logic gate, a switch, an application specific integrated circuit (ASIC), a programmable logic controller, or an embedded micro-controller storing computer-readable program code (such as software or firmware) that can be executed by the (micro)-processor. Examples of the controller include but are not limited to the following micro-controllers: ARC 625D, Atmel AT91SAM, Microchip PIC18F26K20, and Silicone Labs C8051F320. A controller of a memory can also be implemented as a part of control logic of the memory. A person skilled in the art also knows that, in addition to implementing the controller in a pure computer-readable program code way, logic programming can absolutely be performed on method steps to enable the controller to implement the same function in a form of a logic gate, a switch, an application specific integrated circuit, a programmable logic controller, or an embedded micro-controller. Therefore, the controller can be considered as a hardware component, and an apparatus configured to implement various functions in the controller can also be considered as a structure in the hardware component. Alternatively or additionally, an apparatus configured to implement various functions can even be considered as both a software module implementing the method and a structure in the hardware component.

Systems, apparatuses, modules, or units that are set forth in the previous implementations can be embodied by a computer chip or an entity or by a product with a specific function. A typical implementation device is a computer. For example, the computer can be a personal computer, a laptop computer, a cellular phone, a camera phone, a smart phone, a personal digital assistant, a media player, a navigation device, an email device, a game console, a tablet computer, a wearable device, or a combination of any of these devices.

For ease of description, the previous apparatus is described by dividing functions into various units. Certainly, when one or more implementations of the present specification are implemented, functions of the units can be implemented in one or more pieces of software and/or hardware.

A person skilled in the art should understand that the implementations of the present specification can be provided as methods, systems, or computer program products. Therefore, one or more implementations of the present specification can use a form of hardware only implementations, software only implementations, or implementations with a combination of software and hardware. Moreover, one or more implementations of the present specification can use a form of a computer program product that is implemented on one or more computer-usable storage media (including but not limited to a disk memory, a CD-ROM, an optical memory, etc.) that include computer-usable program code.

The implementations of the present specification are described with reference to the flowcharts and/or block diagrams of the method, the device (system), and the computer program product according to the implementations of the present specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can alternatively or additionally be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the block diagrams.

These computer program instructions can alternatively or additionally be loaded onto a computer or another programmable data processing device, so that a series of operations and steps are performed on the computer or the another programmable device to generate computer-implemented processing. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), input/output interfaces, network interfaces, and memories.

The memory can include a non-persistent memory, a random access memory (RAM), a non-volatile memory, and/or another form that are in a computer-readable medium, for example, a read-only memory (ROM) or a flash memory (flash RAM). The memory is an example of the computer-readable medium.

The computer-readable medium includes permanent and non-permanent, removable and non-removable media, and can store information by using any method or technology. The information can be a computer-readable instruction, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or their any other variants are intended to cover a non-exclusive inclusion, so a process, a method, a product, or a device that includes a list of elements not only includes those elements but also includes other elements that are not expressly listed, or further includes elements inherent to such process, method, product, or device. Without more constraints, an element limited by the statement “includes a . . . ” does not exclude the existence of additional identical elements in the process, method, product, or device that includes the element.

A person skilled in the art should understand that the implementations of the present specification can be provided as methods, systems, or computer program products. Therefore, one or more implementations of the present specification can use a form of hardware only implementations, software only implementations, or implementations with a combination of software and hardware. Moreover, one or more implementations of the present specification can use a form of a computer program product that is implemented on one or more computer-usable storage media (including but not limited to a disk memory, a CD-ROM, an optical memory, etc.) that include computer-usable program code.

One or more implementations of the present specification can be described in the general context of computer-executable instructions executed by a computer, for example, a program module. Generally, the program module includes a routine, a program, an object, a component, a data structure, etc. executing a specific task or implementing a specific abstract data type. One or more implementations of the present specification can alternatively or additionally be practiced in distributed computing environments in which tasks are performed by remote processing devices that are connected through a communications network. In the distributed computing environments, the program module can be located in local and remote computer storage media including storage devices.

The implementations of the present specification are described in a progressive way. For same or similar parts of the implementations, mutual references can be made to the implementations. Each implementation focuses on a difference from other implementations. In particular, for implementation of a system, because implementation of the system is basically similar to method implementation, description is relatively simple, and references can be made to parts of the method implementation descriptions.

The previous descriptions are merely implementations of the present specification and are not intended to limit the present specification. A person skilled in the art can make various modifications and variations to the present specification. Any modifications, equivalent replacements, and improvements made within the spirit and principle of the present specification shall fall within the scope of the claims in the present specification.

What is claimed is:

1. A data processing method, comprising:
obtaining to-be-detected target data, the target data including content data of a human-computer interaction;
obtaining a target probability that the target data corresponds to each candidate user intention;
dividing the target data to obtain a plurality of pieces of subdata;
obtaining, based on a gradient integration algorithm, a contribution of each piece of subdata to a correspondence level between the target data and each candidate user intention; and
determining a target user intention corresponding to the target data based on the target probability that the target data corresponds to each candidate user intention and the contribution of each piece of subdata to the correspondence level between the target data and each candidate user intention.

2. The method according to claim 1, further comprising: before the obtaining the target probability that the target data corresponds to each candidate user intention,
determining a first vector corresponding to the target data, and determining, based on a intention recognition model and the first vector, a first probability that the target data corresponds to each first user intention; and
determining, as a candidate user intention, a first user intention corresponding to a first probability that is greater than a first probability threshold and not greater than a second probability threshold,
wherein the determining the target user intention corresponding to the target data based on the target probability that the target data corresponds to each candidate user intention and the contribution of each piece of subdata to the correspondence between the target data and each candidate user intention includes:
determining, as a second user intention, a first user intention corresponding to a first probability that is greater than a third probability threshold; and
determining the target user intention corresponding to the target data based on the second user intention, the target probability that the target data corresponds to each candidate user intention, and the contribution of each piece of subdata to the correspondence between the target data and each candidate user intention.

3. The method according to claim 2, wherein the obtaining the target probability that the target data corresponds to each candidate user intention includes:
replacing a word vector corresponding to the target data with a replacement word vector, and determining a second vector corresponding to the target data based on the replacement word vector;
determining, based on the intention recognition model and the second vector, a second probability that the target data corresponds to each candidate user intention; and
determining, based on the first probability and the second probability, the target probability that the target data corresponds to each candidate user intention.

4. The method according to claim 3, wherein the determining the second vector corresponding to the target data based on the replacement word vector includes:
obtaining a location vector of each word in the target data and a segment vector of each word in the target data; and
determining the second vector corresponding to the target data based on the replacement word vector, the location vector, and the segment vector.

5. The method according to claim 4, wherein the determining the target user intention corresponding to the target data based on the second user intention, the target probability that the target data corresponds to each candidate user intention, and the contribution of each piece of subdata to the correspondence between the target data and each candidate user intention includes:
determining, as a potential user intention, a candidate user intention corresponding to a contribution that is lower than a contribution threshold; and
determining the target user intention corresponding to the target data based on the second user intention and the potential user intention.

6. The method according to claim 5, wherein the target data is data required for performing a target service, and the method further includes:
obtaining a first risk control policy corresponding to the second user intention and a second risk control policy corresponding to the potential user intention, and performing risk detection on the target service based on the first risk control policy and the second risk control policy, to determine whether there is a risk in execution of the target service.

7. The method according to claim 5, further comprising:
training the intention recognition model based on the target data and the target user intention to obtain a trained intention recognition model.

8. A computing device, comprising:
one or more a processors; and
one or more memory devices configured to store computer-executable instructions, the computer-executable instructions, when executed by the one or more processors, configured to enable the one or more processors to, individually or collectively, implement acts including:
obtaining to-be-detected target data, the target data including content data of a human-computer interaction;
obtaining a target probability that the target data corresponds to each candidate user intention;
dividing the target data to obtain a plurality of pieces of subdata;
obtaining, based on a gradient integration algorithm, a contribution of each piece of subdata to a correspondence level between the target data and each candidate user intention; and
determining a target user intention corresponding to the target data based on the target probability that the target data corresponds to each candidate user intention and the contribution of each piece of subdata to the correspondence level between the target data and each candidate user intention.

9. The computing device according to claim 8, wherein the acts further include: before the obtaining the target probability that the target data corresponds to each candidate user intention,
determining a first vector corresponding to the target data, and determining, based on a intention recognition model and the first vector, a first probability that the target data corresponds to each first user intention; and
determining, as a candidate user intention, a first user intention corresponding to a first probability that is greater than a first probability threshold and not greater than a second probability threshold, and
wherein the determining the target user intention corresponding to the target data based on the target probability that the target data corresponds to each candidate user intention and the contribution of each piece of subdata to the correspondence between the target data and each candidate user intention includes:
determining, as a second user intention, a first user intention corresponding to a first probability that is greater than a third probability threshold; and
determining the target user intention corresponding to the target data based on the second user intention, the target probability that the target data corresponds to each candidate user intention, and the contribution of each piece of subdata to the correspondence between the target data and each candidate user intention.

10. The computing device according to claim 9, wherein the obtaining the target probability that the target data corresponds to each candidate user intention includes:
replacing a word vector corresponding to the target data with a replacement word vector, and determining a second vector corresponding to the target data based on the replacement word vector;
determining, based on the intention recognition model and the second vector, a second probability that the target data corresponds to each candidate user intention; and
determining, based on the first probability and the second probability, the target probability that the target data corresponds to each candidate user intention.

11. The computing device according to claim 10, wherein the determining the second vector corresponding to the target data based on the replacement word vector includes:
obtaining a location vector of each word in the target data and a segment vector of each word in the target data; and
determining the second vector corresponding to the target data based on the replacement word vector, the location vector, and the segment vector.

12. The computing device according to claim 11, wherein the determining the target user intention corresponding to the target data based on the second user intention, the target probability that the target data corresponds to each candidate user intention, and the contribution of each piece of subdata to the correspondence between the target data and each candidate user intention includes:
determining, as a potential user intention, a candidate user intention corresponding to a contribution that is lower than a contribution threshold; and
determining the target user intention corresponding to the target data based on the second user intention and the potential user intention.

13. The computing device according to claim 12, wherein the target data is data required for performing a target service, and the method further includes:
obtaining a first risk control policy corresponding to the second user intention and a second risk control policy corresponding to the potential user intention, and performing risk detection on the target service based on the first risk control policy and the second risk control policy, to determine whether there is a risk in execution of the target service.

14. The computing device according to claim 12, wherein the acts further include:
training the intention recognition model based on the target data and the target user intention to obtain a trained intention recognition model.

15. A storage medium having computer-executable instructions stored thereon, the computer-executable instructions, when executed by one or more processors, enabling the one or more processors to, individually or collectively, implement acts comprising:
obtaining to-be-detected target data, the target data including content data of a human-computer interaction;
obtaining a target probability that the target data corresponds to each candidate user intention;
dividing the target data to obtain a plurality of pieces of subdata;
obtaining, based on a gradient integration algorithm, a contribution of each piece of subdata to a correspondence level between the target data and each candidate user intention; and
determining a target user intention corresponding to the target data based on the target probability that the target data corresponds to each candidate user intention and the contribution of each piece of subdata to the correspondence level between the target data and each candidate user intention.

16. The storage medium according to claim 15, wherein the acts further include: before the obtaining the target probability that the target data corresponds to each candidate user intention,
determining a first vector corresponding to the target data, and determining, based on a intention recognition model and the first vector, a first probability that the target data corresponds to each first user intention; and
determining, as a candidate user intention, a first user intention corresponding to a first probability that is greater than a first probability threshold and not greater than a second probability threshold, and
wherein the determining the target user intention corresponding to the target data based on the target probability that the target data corresponds to each candidate user intention and the contribution of each piece of subdata to the correspondence between the target data and each candidate user intention includes:
determining, as a second user intention, a first user intention corresponding to a first probability that is greater than a third probability threshold; and
determining the target user intention corresponding to the target data based on the second user intention, the target probability that the target data corresponds to each candidate user intention, and the contribution of each piece of subdata to the correspondence between the target data and each candidate user intention.

17. The storage medium according to claim 16, wherein the obtaining the target probability that the target data corresponds to each candidate user intention includes:
replacing a word vector corresponding to the target data with a replacement word vector, and determining a second vector corresponding to the target data based on the replacement word vector;
determining, based on the intention recognition model and the second vector, a second probability that the target data corresponds to each candidate user intention; and
determining, based on the first probability and the second probability, the target probability that the target data corresponds to each candidate user intention.

18. The storage medium according to claim 17, wherein the determining the second vector corresponding to the target data based on the replacement word vector includes:
obtaining a location vector of each word in the target data and a segment vector of each word in the target data; and
determining the second vector corresponding to the target data based on the replacement word vector, the location vector, and the segment vector.

19. The storage medium according to claim 18, wherein the determining the target user intention corresponding to the target data based on the second user intention, the target probability that the target data corresponds to each candidate user intention, and the contribution of each piece of subdata to the correspondence between the target data and each candidate user intention includes:
determining, as a potential user intention, a candidate user intention corresponding to a contribution that is lower than a contribution threshold; and
determining the target user intention corresponding to the target data based on the second user intention and the potential user intention.

20. The storage medium according to claim 19, wherein the target data is data required for performing a target service, and the method further includes:
obtaining a first risk control policy corresponding to the second user intention and a second risk control policy corresponding to the potential user intention, and performing risk detection on the target service based on the first risk control policy and the second risk control policy, to determine whether there is a risk in execution of the target service.
